(19) United States
(12) Patent Application Publication
(10) Pub. No.: US 2026/0030799 A1
(43) Pub. Date: Jan. 29, 2026

(54) Optimizing and Simplifying Rendering of Data Points in a Visualization

(71) Applicant: Salesforce, Inc., San Francisco, CA (US)

(72) Inventor: Subrata ASHE, Walnut Creek, CA (US)

(21) Appl. No.: 19/009,856

(22) Filed: Jan. 3, 2025

Related U.S. Application Data
(60) Provisional application No. 63/676,240, filed on Jul. 26, 2024.

(51) Int. Cl. G06T 11/00; G06F 16/215; G06F 16/26

(52) U.S. Cl. CPC G06T 11/001; G06F 16/215; G06F 16/26

(57) ABSTRACT

A computing device executing a browser application obtains a dataset for rendering a data visualization, the dataset including a plurality of data points. The device selects, from the plurality of data points, a first subset of data points according to a statistical data distribution of the dataset. The device recursively applies a first algorithm to the first subset of data points to obtain a final subset of data points. Each of first subset of data points and the final subset of data points has a fewer number of data points than the plurality of data points. The device renders a data visualization using the browser application. The data visualization has a plurality of data marks corresponding to the final subset of data points. The device displays, on the browser application, the data visualization including the plurality of data marks.

### RELATED APPLICATIONS

This application claims priority to U.S. Provisional Patent Application No. 63/676,240, filed, Jul. 26, 2024, titled “Optimizing and Simplifying Rendering of Data Points in a Visualization,” which is incorporated by reference herein in its entirety.

### TECHNICAL FIELD

The disclosed embodiments relate generally to data analysis, and more specifically to systems, methods, and user interfaces for visualizing datasets in a browser-based environment.

### BACKGROUND

Visualizing vast datasets in a browser-based environment presents significant technical challenges, particularly in rendering efficiency and system stability. Traditional rendering methods often lead to browser crashes and sluggish performance due to memory constraints and processing demands.

### SUMMARY

Data visualization plays a crucial role in data analysis by enabling users to discern patterns, trends, and insights from large volumes of data. With the exponential growth in data generation and collection, datasets with hundreds of thousands, or millions, or tens of millions of data points becoming increasingly common. Visually large datasets effectively has become a critical requirement in various fields such as data science, finance, and scientific research.

Modern web technologies, while powerful, often fall short when tasked with rendering data points (e.g., data marks) of large datasets in a single visualization real-time. Current browser engines with full client side rendering, such as Chrome's V8 engine, are designed to handle a wide range of web applications but they have inherent limitations when it comes to rendering extensive datasets. One of the limitations has to do with memory management. When a browser attempts to render millions of data points, the memory usage can increase dramatically, often surpassing the browser's limits. This leads to crashes, commonly known as the “Aww, Snap!” error, which disrupts the user's workflow and renders the visualization tool ineffective for large-scale data analysis. Another limitation is processing speed. Browser engines struggle with processing speed when dealing with extensive datasets. The time taken to render each data point can accumulate, resulting in slow and unresponsive visualizations. This delay can be detrimental, especially in environments where real-time data analysis is crucial.

The ability to render data visualizations quickly and efficiently is vital for effective data visualization, as users need to quickly identify patterns, trends, and anomalies without being bogged down by the technical limitations of the rendering process. An optimized approach ensures that the visualizations are not only accurate but also performant, providing a seamless user experience. The focus should be on delivering the most pertinent information efficiently, without overwhelming the system's resources.

Accordingly, there is a need for improved methods and systems for optimizing and simplifying the rendering process. Generally speaking, users typically do not need to see every single data point but are more interested in understanding the overall patterns and trends within the data. Accordingly, an effective visualization strategy should focus on reducing data complexity while maintaining visual accuracy and clarity.

Some embodiments of the present disclosure introduce a novel approach to optimizing and simplifying the rendering of large datasets. In some embodiments, a dataset that is used to render a data visualization can include over hundreds of thousands, or millions, or over tens of millions of data values (e.g., data points), which can cause browser crashes and sluggish performance in traditional rendering approaches due to memory constraints and processing demands.

Some embodiments of the present disclosure customize the Douglas-Peucker (DP) algorithm with a QuadTree data structure to address these issues effectively. The DP algorithm, traditionally used in cartographic and deep-space surveys, simplifies polylines by reducing the number of points while preserving their essential shape. Some embodiments of the present disclosure further enhance the efficiency of this algorithm by implementing incremental sampling and parallel processing. The QuadTree data structure provides an efficient way to organize and query spatial data. By recursively subdividing the space into smaller regions, the QuadTree allows for efficient data management and retrieval, reducing the computational load during the rendering process.

In some embodiments, the disclosed techniques improve over existing client side rendering approaches by:
(i) Reducing data complexity: The dataset can be simplified to highlight patterns without rendering every individual data point;
(ii) Reducing processing time: The data is organized spatially, and redundant points are removed to expedite query responses and rendering. As disclosed, in some embodiments, the processing time is improved (e.g., reduced) by about 90%;
(iii) Improving resource utilization. For example, the disclosed embodiments improve the computer system by reducing JavaScript memory usage to enhance browser performance and prevent crashes. As disclosed, in some embodiments, the JavaScript memory usage can be reduced by about 78%; and
(iv) Enhancing user experience. The disclosed embodiments improve the user experience by providing smoother and faster visual interactions at reduced rendering times. In some embodiments, the rendering time can be reduced by about 99%.

As disclosed, the DP algorithm with QuadTree data structure can be applied across various chart types, including line charts, bar charts, and scatter plots. The adaptability of the approach allows for configurable gains, ensuring that it can be tailored to specific visualization needs. The present disclosure provides a robust technical solution to the technical challenges of rendering large-scale visualizations. The disclosed embodiments provide a practical and highly efficient method for real-time data analysis and visualization in browser environments.

In some embodiments, the differentiators of the disclosed embodiments compared to existing solutions include:
development and implementation of a customized Douglas-Peucker algorithm with quadtrees for working in resource starved browsers while retaining all the data points. In some embodiments, the algorithm is configured to be implemented for chart types such as bar charts, line graphs, multi-line plots, and Sankey charts;
the use of incremental segmentation of data and sampling (e.g., using data predictions and machine learning) to determine how many data marks need to be rendered on the visualization. In some embodiments, as a user hovers their cursor over a section of the visualization, the user interaction causes that section of the visualization to be automatically re-rendered with the full set of data marks without impacting user experience; and
efficient parallelism and dynamic use of web-workers causes a rendering that includes tens of millions of marks/data points to be generated in approximately 50 milliseconds (currently not achievable in any other browser-based environment implementations).

The systems, methods, and user interfaces of this disclosure each have several innovative aspects, no single one of which is solely responsible for the desirable attributes disclosed herein.

In accordance with some embodiments, a method for visualizing large datasets is performed by a computing device executing a browser application. The method includes obtaining a dataset for rendering a data visualization. The dataset includes a plurality of data points. The method includes selecting, from the plurality of data points, a first subset of data points according to a statistical data distribution of the dataset. The method includes recursively applying a first algorithm (e.g., Douglas-Peucker algorithm or Visvalingam-Whyatt algorithm) to the first subset of data points to obtain a final subset of data points, where each of first subset of data points and the final subset of data points has a fewer number of data points than the plurality of data points. The method includes rendering a data visualization using the browser application. The data visualization includes a plurality of data marks corresponding to the final subset of data points. The method includes displaying, on the browser application, the data visualization including the plurality of data marks.

In accordance with some embodiments, a computing device includes a display, one or more processors, and memory coupled to the one or more processors. The memory stores one or more programs configured for execution by the one or more processors. The one or more programs include instructions for performing any of the methods disclosed herein.

In accordance with some embodiments, a non-transitory computer readable storage medium stores one or more programs configured for execution by a computing device having a display, one or more processors, and memory. The one or more programs include instructions for performing any of the methods disclosed herein.

Thus methods, systems, and graphical user interfaces are disclosed that optimizes the rendering of data points in data visualizations.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

For a better understanding of the aforementioned systems, methods, and graphical user interfaces, as well as additional systems, methods, and graphical user interfaces that provide data visualization analytics, reference should be made to the Detailed Description of Embodiments below, in conjunction with the following drawings in which like reference numerals refer to corresponding parts throughout the figures.

FIG. 1 illustrates a data visualization that is rendered using all data points of a dataset, in accordance with some embodiments.

FIG. 2 illustrates a data visualization that is rendered using a subset of data points of the same dataset that is used to render the visualization in FIG. 1, in accordance with some embodiments.

FIG. 3 compares a zoomed-in region of the data visualization in FIG. 1 (left) with a zoomed-in region of the data visualization in FIG. 2 (right), in accordance with some embodiments.

FIG. 4 provides a block diagram of a computing device, in accordance with some embodiments.

FIG. 5 provides a block diagram of a server system, in accordance with some embodiments.

FIGS. 6A-6F provide a flowchart of a method for visualizing large datasets, in accordance with some embodiments,

Reference will now be made to embodiments, examples of which are illustrated in the accompanying drawings. In the following description, numerous specific details are set forth in order to provide a thorough understanding of the present invention. However, it will be apparent to one of ordinary skill in the art that the present invention may be practiced without requiring these specific details.

### DETAILED DESCRIPTION OF EMBODIMENTS

In accordance with some embodiments, techniques such as the Douglas-Peucker (DP) algorithm, the Visvalingam-Whyatt (VW) algorithm, and/or a QuadTree data structure can be employed to optimize the rendering of large datasets.

DP algorithm. The DP algorithm simplifies polylines by reducing the number of points while preserving the overall shape of the data. Originally developed for cartographic applications, the DP algorithm is adept at handling large volumes of data points by recursively removing points that do not significantly alter the visual representation of the line. This process significantly reduces the computational load, making it feasible to render large datasets more efficiently. In some embodiments, the DP algorithm works by recursively selecting the most significant points and discarding the less significant ones based on a specified tolerance level. This tolerance determines the degree of simplification, balancing between detail and performance. In some embodiments, enhancements to the DP algorithm, such as incremental sampling, parallel processing, and dynamic tolerance adjustment, further improve its efficiency and adaptability to various types of visualizations.

VW algorithm. The Visvalingam-Whyatt (VW) algorithm, or simply the Visvalingam algorithm, is an algorithm that is primarily used in cartographic generalization. The VW algorithm assigns points in a curve an importance value based on local conditions and removes points from the least important to most important. The algorithm decimates a curve composed of line segments to a similar curve with fewer points.

QuadTree Data Structure. The QuadTree data structure is another technique used to optimize data rendering. A QuadTree is a hierarchical data structure that partitions a two-dimensional space into smaller regions, or quadrants, based on the distribution of the data points. This spatial subdivision allows for efficient organization and retrieval of data, significantly reducing the computational overhead during the rendering process. QuadTrees are particularly effective in handling large, sparse datasets where data points are unevenly distributed. By dynamically adjusting the level of subdivision based on data density, QuadTrees ensure that each region contains a manageable number of data points, facilitating faster queries and rendering.

### Optimization

Some embodiments are directed to an enhanced algorithm (e.g., algorithm(s) 436) that enhances how data is processed before rendering. The algorithm focuses on incremental sampling and simplification, parallelization, dynamic runtime tolerance, and broad applicability across different types of visualizations, as will be described below.

### Incremental Sampling and Simplification.

In some embodiments, instead of processing the entire dataset at once, a subset of points is sampled and algorithm(s) 436, such as the DP algorithm and/or the VW algorithm, are applied to the sampled data. After the initial simplification, additional segments are incrementally added to the sample, and the DP algorithm (or the VW algorithm) is re-applied. This approach distributes the computational load more evenly across the entire dataset, significantly improving responsiveness and reducing the risk of overloading the system. By breaking down the data into manageable chunks, the rendering process becomes more efficient, making it feasible to handle larger datasets without compromising performance.

### Parallelization.

To further enhance performance, some embodiments of the present disclosure adapt the DP algorithm or the VW algorithm to leverage parallel processing through web workers. Web workers allow multiple threads to execute independently, enabling parallel segments of data to be processed simultaneously. This parallelization reduces overall latency and accelerates the rendering process. However, this method comes with its own set of challenges, such as managing inter-thread communication and synchronizing results. In some embodiments, the parallel processing includes partial parallel processing, with ongoing investigations to optimize this approach. Processing the data in batches helps control the granularity of computation, ensuring that each batch is processed efficiently without overwhelming the system.

### Dynamic Runtime Tolerance.

Traditional implementations of the DP algorithm rely on a fixed tolerance level to determine the degree of simplification. Some implementations of the present disclosure incorporate a dynamic runtime tolerance, which allowed the algorithm to adaptively determine the best tolerance level based on the characteristics of the data. This is achieved through an adjustable parameter known as “Tolerance Fraction,” which fine-tunes the simplification process in real-time. By dynamically adjusting the tolerance, the algorithm ensures that the visual representation remains accurate while optimizing performance, even when dealing with varying data densities and complexities.

### Versatility Across Visualization Types.

One of the significant advantages of the proposed approach is its versatility. As disclosed, in some embodiments, the enhanced algorithm is designed to work seamlessly with various types of visualizations, including line charts, bar charts, scatter plots, and more. This flexibility ensures that the benefits of optimized rendering and improved performance can be realized across different use cases and visualization requirements. Whether dealing with continuous data in line charts or discrete data in bar charts, the algorithm adapts to provide efficient and accurate visualizations.

### Tuning the Minimum/Maximum Nodes in QuadTree Implementation.

In some embodiments, the QuadTree data structure is applied for organizing and optimizing spatial data for efficient querying and rendering. Quadtree is a hierarchical data structure which partitions a two-dimensional space into smaller regions. It works by recursively subdividing the space into quadrants, each containing a subset of data points. It also dynamically adjusts its structure based on the distribution of data points. In some embodiments, as data points and inserted or removed, the enhanced algorithm rebalances the tree to maintain optimal performance. In some embodiments, a crucial aspect of the implementation of the QuadTree data structure involves tuning the minimum and maximum number of nodes (or data points) within each quadrant. This tuning process significantly impacts the performance and efficiency of data retrieval and rendering.

Minimum nodes. The minimum number of nodes in a quadrant determines when the quadrant should stop subdividing. If a quadrant has fewer nodes than the specified minimum, it will not be further subdivided. Tuning this parameter (i.e., minimum number of nodes) can prevent over-segmentation, which can lead to unnecessary computational overhead. A higher minimum value reduces the depth of the tree, thus speeding up the querying process, but may result in less precise spatial partitioning.

Maximum nodes. The maximum number of nodes in a quadrant dictates when a quadrant should be subdivided into smaller quadrants. When the number of nodes exceeds this threshold, the quadrant is split into four child quadrants. Setting an appropriate maximum value is crucial for balancing between tree depth and spatial precision. A lower maximum value ensures finer partitioning, which can improve the accuracy of data queries but may increase the tree's depth, potentially leading to higher memory usage and slower traversal times.

In some embodiments, by carefully tuning the minimum/maximum nodes, the QuadTree can be optimized for specific datasets and visualization requirements. For example, sparse datasets may benefit from higher minimum and maximum values to avoid deep trees, while dense datasets might require lower values to ensure finer partitioning and accurate data retrieval.

### Tuning the Tolerance Fraction.

The “tolerance fraction parameter” in the DP algorithm dynamically adjusts the tolerance level for data simplification. This parameter balances between data reduction and visual accuracy.

Dynamic Adjustment. In some embodiments, the tolerance fraction allows the algorithm to adaptively determine the best tolerance level based on the data's characteristics. By setting an appropriate fraction, the algorithm can fine-tune the simplification process, ensuring that significant points are retained while less critical points are removed.

Data-Driven Optimization. Different datasets have varying levels of detail and noise. The tolerance fraction parameter provides a mechanism to tailor the simplification process to the specific needs of the dataset. For example, high-frequency data with many fluctuations might require a lower tolerance fraction to preserve critical details, while smoother data can tolerate a higher fraction, resulting in more significant simplification.

Performance and Accuracy Trade-off. In some embodiments, adjusting the tolerance fraction can facilitate achieving an optimal balance between performance and visual accuracy. A lower fraction enhances accuracy but may increase computational load, whereas a higher fraction reduces the load at the cost of some detail. By dynamically adjusting this parameter, the algorithm ensures efficient rendering without compromising on the essential visual characteristics of the data.

### Adding Client-Side Data Preprocessor Before Adding Data Marks.

Some embodiments incorporate a client-side data preprocessor (e.g., data processing module 434) before rendering visualization marks. This provides several advantages, particularly in enhancing performance and optimizing the data for visualization.

Data Cleaning and Transformation. In some embodiments, the client-side data pre-processor can perform initial data cleaning and transformation tasks. This includes handling missing values, filtering outliers, normalizing data, and converting data types. Pre-processing ensures that the data is in the best possible shape for rendering, reducing the likelihood of errors and inconsistencies.

Simplification and Reduction. In some embodiments, before passing the data to the rendering engine, the pre-processor can apply simplification algorithms, such as the DP algorithm. This step reduces the number of data points by eliminating redundant or insignificant points, thereby decreasing the computational load during rendering.

Feature extraction. In some embodiments, the pre-processor can perform feature extraction to identify and retain only the most relevant features of the data. Feature extraction can be particularly useful for complex datasets with numerous attributes, enabling more focused and efficient visualizations.

Segmentation and Batching. In some embodiments, data can be segmented into smaller, more manageable batches. This segmentation allows for incremental processing and rendering, which is especially beneficial for large datasets. By processing and rendering data in smaller chunks, the system can maintain responsiveness and avoid overwhelming the browser.

Client-Side Computation. In some embodiments, offloading some computation to the client-side reduces the burden on the server, distributing the processing load. This can lead to faster data retrieval and rendering times, enhancing the overall user experience.

In some embodiments, the benefits of client-side data pre-processing include:
Improved Performance: By pre-processing data on the client side, the amount of data passed to the rendering engine is reduced, leading to faster rendering times and more efficient memory usage.
Enhanced User Experience: By pre-processing data on the client side users experience smoother interactions and quicker load times, as the pre-processing step ensures that only the most relevant and optimized data is rendered.
Scalability: In some embodiments, client-side preprocessing allows the system to handle larger datasets more effectively, distributing the processing load and preventing server bottlenecks.
Customization: Pre-processing enables more customized visualizations, as data can be tailored to specific visualization needs before rendering.

### Utilizing Machine Learning for Data Sampling in the DP Algorithm

In some embodiments, one or more machine learning (ML) algorithms (e.g., machine learning models 460) are integrated into the data sampling process for the DP algorithm. By leveraging ML techniques directly within the browser, it becomes possible to dynamically analyze data distribution and intelligently identify which data points or data marks need to be grouped or simplified. This approach ensures that the most relevant and significant points are retained for visualization, while redundant or less important points are effectively filtered out.

Dynamic Data Distribution Analysis. In some embodiments, the ML algorithm operates in the browser to continuously analyze the incoming data stream. It calculates the distribution of the data points, identifying clusters, outliers, and patterns that are crucial for an accurate and meaningful visualization. This real-time analysis allows for a more nuanced understanding of the data, enabling the system to make informed decisions about which points to sample for the DP algorithm.

Intelligent Mark Identification and Grouping. In some embodiments, based on the data distribution analysis, the ML algorithm identifies the marks that should be grouped together. This involves clustering similar data points and determining the significance of each cluster in the context of the overall dataset. By focusing on these key clusters, the algorithm ensures that the most visually and analytically important points are preserved during the simplification process.

Implementing ML in the browser. In some embodiments, to ensure that the ML algorithm runs efficiently in the browser, lightweight models with a customized k-means clustering and simple neural networks are used. These models are optimized for quick execution and low memory usage, making them suitable for real-time data processing in a browser environment. In some embodiments, the ML models are implemented using WebAssembly, which allows for near-native execution speeds in the browser. Additionally, web workers are utilized to run the ML algorithm in parallel with the main rendering process. This parallelization ensures that the data analysis does not interfere with the user interface or the rendering of visualizations.

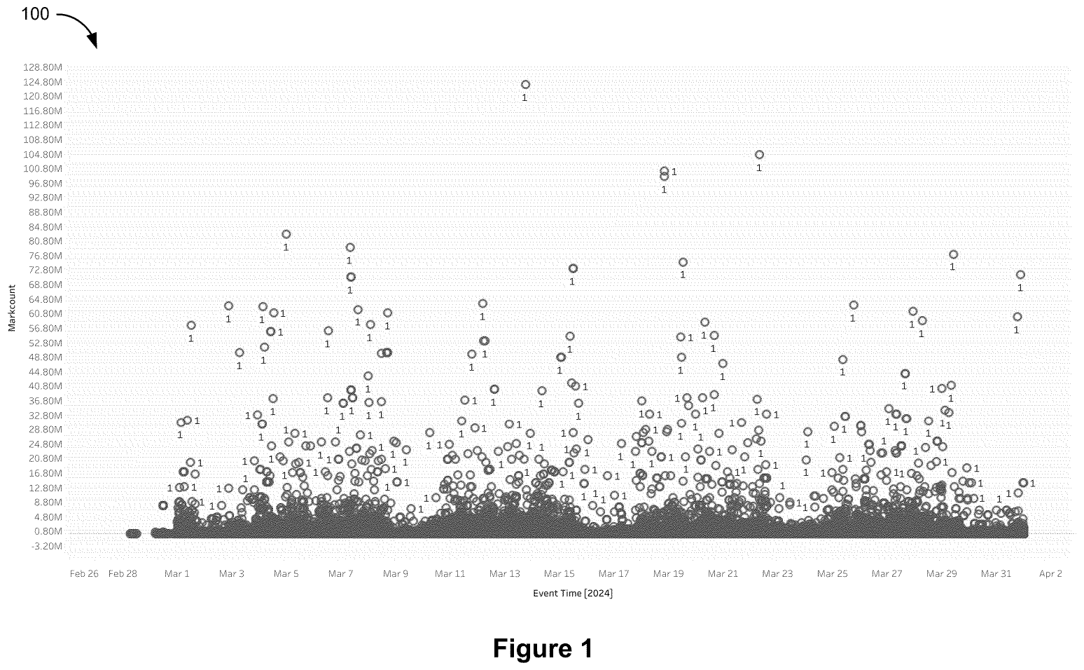

FIG. 1 illustrates a data visualization 100 that is rendered using all data points of a dataset, in accordance with some embodiments. In this example, the total number of data marks in the data visualization 100 is 19,342,787 (˜19.4 million).

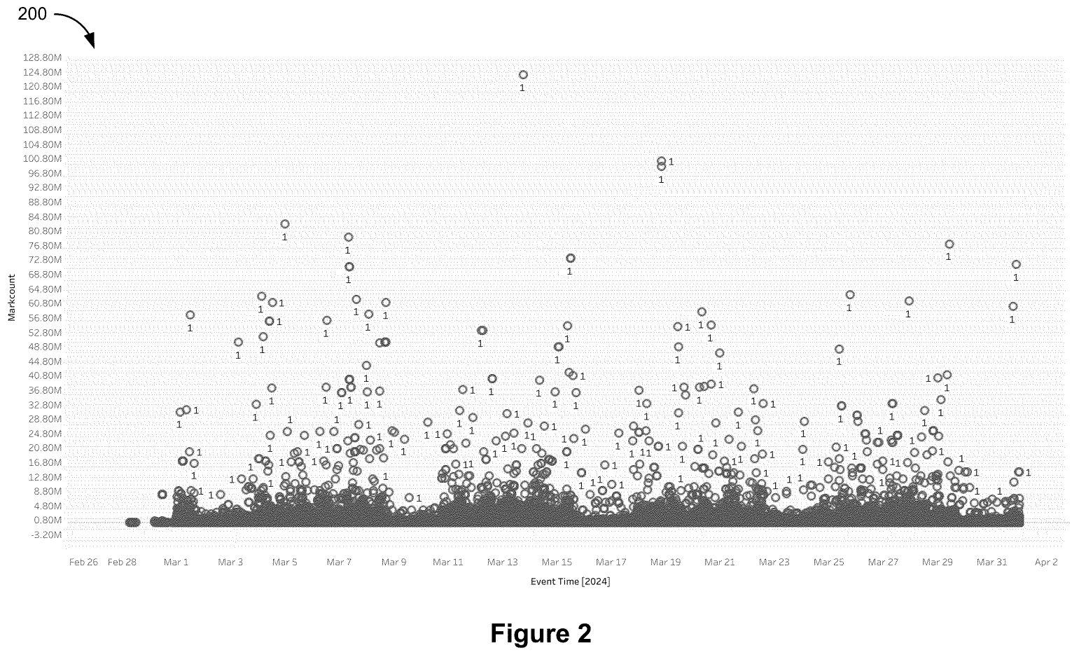

FIG. 2 illustrates a data visualization 200 that is rendered using a reduced number of data points of the same dataset that is used to render the data visualization 100. In this example, the data visualization 200 is rendered using 2,011,030 (˜2 million) data points. Even though the data visualization 200 uses only about 10% of the total number of data points in the dataset, the user's visual perception of the data visualization is not impacted.

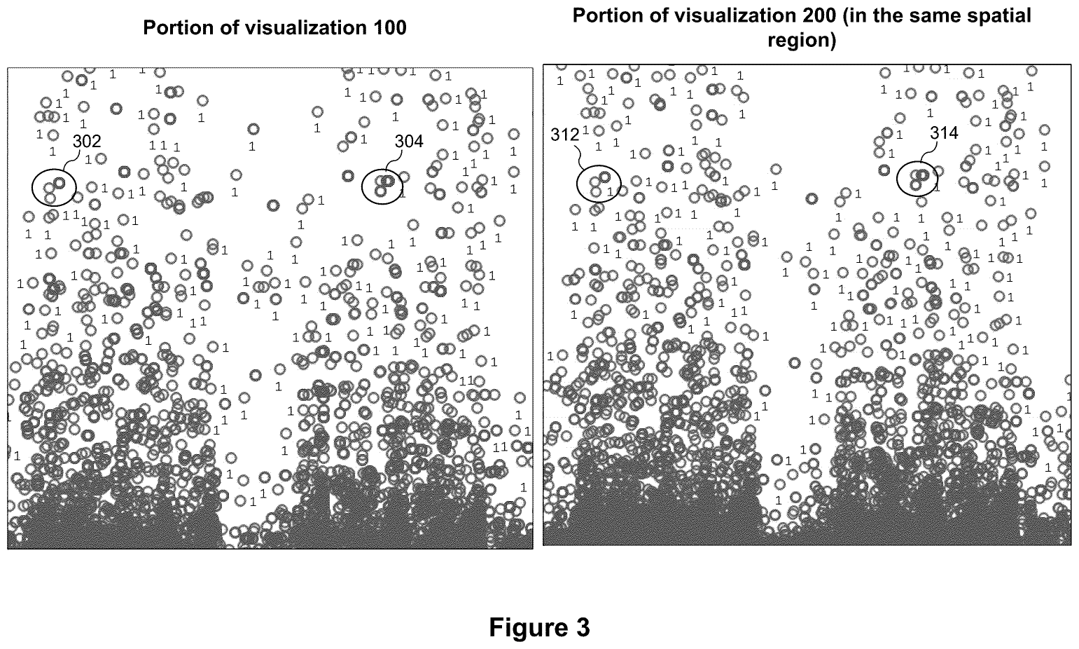

FIG. 3 shows, on the left image, a portion of data visualization 100. The right image of FIG. 3 is a portion of data visualization 200 from approximately the same spatial area. Even though data visualization 200 has fewer data marks compared to data visualization 100, the perceived appearance change of the visualization is minimally impacted. For example, data visualization 100 (left image) includes a cluster 302 of data marks, where the top right mark appears to have a thicker outline due to the presence of overlapping marks in that region. FIG. 3 illustrates that data visualization 200 (right image) includes a similar cluster 312 of data marks with the same visual appearance. A similar situation applies for the cluster 304 of data marks in the data visualization 100 and the cluster 314 of data marks in the data visualization 200.

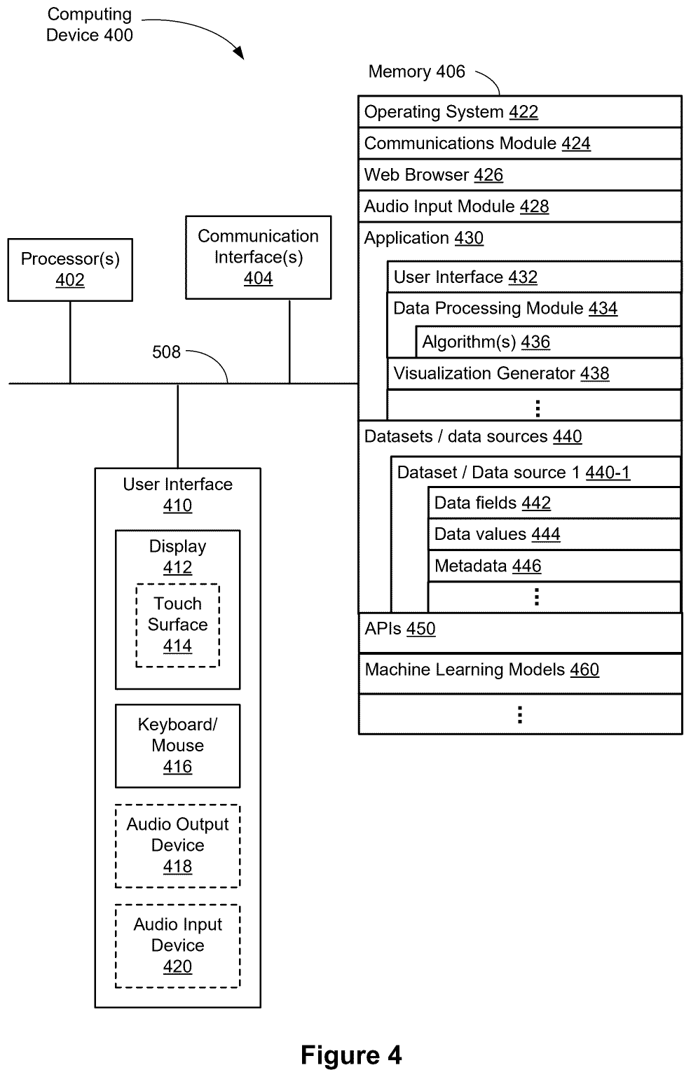

FIG. 4 is a block diagram of a computing device 400 for visualizing large datasets, in accordance with some embodiments. Various examples of the computing device 400 include a desktop computer, a laptop computer, a tablet computer, and other computing devices that have a display and a processor capable of running an application 430. The computing device 400 typically includes one or more processors (processing units or cores) 402, one or more network or other communication interfaces 404, memory 406, and one or more communication buses 408 for interconnecting these components. In some embodiments, the communication buses 408 include circuitry (sometimes called a chipset) that interconnects and controls communications between system components.

The computing device 400 includes a user interface 410. The user interface 410 typically includes a display device 412. In some embodiments, the computing device 400 includes input devices such as a keyboard, mouse, and/or other input buttons 416. Alternatively or in addition, in some embodiments, the display device 412 includes a touch-sensitive surface 414, in which case the display device 412 is a touch-sensitive display. In some embodiments, the touch-sensitive surface 414 is configured to detect various swipe gestures (e.g., continuous gestures in vertical and/or horizontal directions) and/or other gestures (e.g., single/double tap). In computing devices that have a touch-sensitive display 414, a physical keyboard is optional (e.g., a soft keyboard may be displayed when keyboard entry is needed). The user interface 410 also includes an audio output device 418, such as speakers or an audio output connection connected to speakers, earphones, or headphones. Furthermore, some computing devices 400 use a microphone and voice recognition to supplement or replace the keyboard. In some embodiments, the computing device 400 includes an audio input device 420 (e.g., a microphone) to capture audio (e.g., speech from a user).

In some embodiments, the memory 406 includes high-speed random-access memory, such as DRAM, SRAM, DDR RAM, or other random-access solid-state memory devices. In some embodiments, the memory 406 includes non-volatile memory, such as one or more magnetic disk storage devices, optical disk storage devices, flash memory devices, or other non-volatile solid-state storage devices. In some embodiments, the memory 406 includes one or more storage devices remotely located from the processors 402. The memory 406, or alternatively the non-volatile memory devices within the memory 406, includes a non-transitory computer-readable storage medium. In some embodiments, the memory 406, or the computer-readable storage medium of the memory 406, stores the following programs, modules, and data structures, or a subset or superset thereof:
an operating system 422, which includes procedures for handling various basic system services and for performing hardware dependent tasks;
a communications module 424, which is used for connecting the computing device 400 to other computers (e.g., server 500) and devices via the one or more communication interfaces 404 (wired or wireless), such as the Internet, other wide area networks, local area networks, metropolitan area networks, and so on;
a web browser 426 (or other application capable of displaying web pages), which enables a user to communicate over a network with remote computers or devices;
an audio input module 428 (e.g., a microphone module), which processes audio captured by the audio input device 420. The captured audio may be sent to a remote server (e.g., a server system 500) and/or processed by an application executing on the computing device 400 (e.g., the application 430);
an application 430 for optimizing the number of data points datasets that are used to render data visualizations. In some embodiments, the application 430 is a browser-based application, meaning that it operates entirely within a web browser (e.g., web browser 426). In some embodiments, the application 430 is an application that is installed on and executes on the computing device. In some embodiments, the application 430 includes:
   a user interface 432 displaying rendered (e.g., generated) data visualizations and for a user to interact with the data visualizations;
   a data processing module 434, for optimizing the rendering visualizations of datasets (e.g., datasets/data sources 440). In some embodiments, a dataset can include at least 100,000 data points, 500,000 data points, 1 million data points, 5 million data points, 10 million data points, 50 million, or 100 million data points In some embodiments, the data processing module 434 applies algorithm(s) 436 to reduce the number of data points in the dataset and at the same time, preserve the visual perception of the data visualization (e.g., as illustrated in FIGS. 1, 2,3 and 3). In some embodiments, the algorithm(s) 436 can include the Douglas-Peucker (DP) algorithm, the Visvalingam-Whyatt (VW) algorithm, and/or enhanced forms of these algorithms that allow for incremental sampling and simplification, parallelization, dynamic runtime tolerance, and broad applicability across different types of visualizations (e.g., as described in the “Optimization” section above). In some embodiments, the data processing module 434 performs initial data cleaning and transformation tasks, feature extraction, segmentation, and batching, as discussed with respect to the “Client-Side Data Preprocessor” section; and
   a visualization generator 438 for generating and displaying data visualizations;
zero or more datasets or data sources 440, which are used by the application 430, and/or the machine learning models 460. In some embodiments, the datasets/data sources 440 include a first dataset or a first data source (e.g., dataset/Data source 1 440-1). In some embodiments, a respective dataset or data source 440 includes data fields 442, data values 444 (e.g., data points) corresponding to the data fields, and metadata 446 of the data fields and/or data values. In some embodiments, the computing device 400 stores each data point of a dataset in a quadtree data structure format;
APIs 450 for receiving API calls from one or more applications (e.g., a web browser 426, application 430, or machine learning models 460), translating the API calls into appropriate actions, and performing one or more actions; and
machine learning models 460, which executes one or more machine learning algorithms for data sampling.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 406 stores a subset of the modules and data structures identified above. Furthermore, the memory 406 may store additional modules or data structures not described above. In some embodiments, a subset of the programs, modules, and/or data stored in the memory 406 is stored on and/or executed by a server system 500.

Although FIG. 4 shows a computing device 400, FIG. 4 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to the computing device 400 may be stored or executed on a server system 500.

In various implementations, the models (e.g., machine learning models 460) and/or modules described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware- or software-based framework for training, processing, fine-tuning, or performing any other implementation steps. Furthermore, the AI technology may include a hardware- or software-based framework that performs one or more functions, such as retrieving, generating, accessing, transmitting, etc.

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set of interval or in real time based on resulting output or additional data to further train the AI technology. The AI technology may offer a variety of capabilities including text, audio, image, or content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

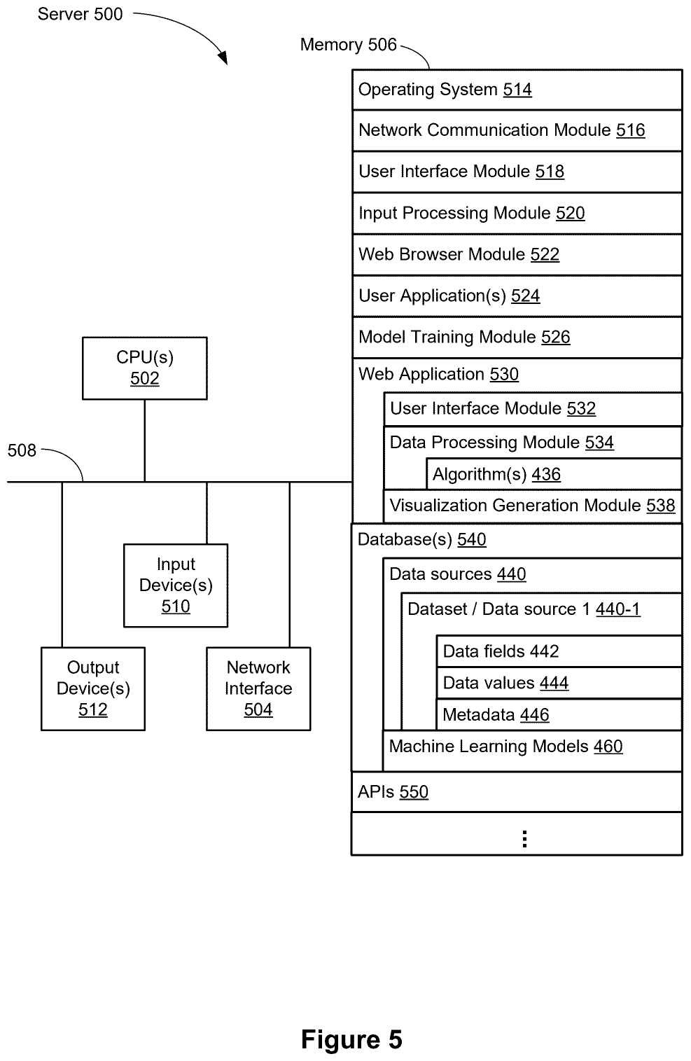

FIG. 5 is a block diagram of a server system 500, in accordance with some embodiments. Examples of the server 500 include, but are not limited to, a server computer, a desktop computer, a laptop computer, a tablet computer, or a mobile phone. The server 500 typically includes one or more processing units (CPUs) 502, one or more network interfaces 504, memory 506, and one or more communication buses 508 for interconnecting these components (sometimes called a chipset). The server 500 includes one or more user interface devices. The user interface devices include one or more input devices 510, which facilitate user input, such as a keyboard, a mouse, a voice-command input unit or microphone, a touch screen display, a touch-sensitive input pad, a gesture capturing camera, or other input buttons or controls. Furthermore, in some embodiments, the server 500 uses a microphone and voice recognition or a camera and gesture recognition to supplement or replace the keyboard. In some embodiments, the one or more input devices 510 include one or more cameras, scanners, or photo sensor units for capturing images, for example, of graphic serial codes printed on electronic devices. The server 500 also includes one or more output devices 512, which enable presentation of user interfaces and display content, including one or more speakers and/or one or more visual displays. The server system 500 typically includes one or more processing units/cores (CPUs) 502, one or more network interfaces 504, memory 506, and one or more communication buses 508 for interconnecting these components. In some embodiments, the communication buses 508 include circuitry (sometimes called a chipset) that interconnects and controls communications between system components.

The memory 506 includes high-speed random access memory, such as DRAM, SRAM, DDR RAM, or other random access solid state memory devices. In some embodiments, the memory includes non-volatile memory, such as one or more magnetic disk storage devices, one or more optical disk storage devices, one or more flash memory devices, or one or more other non-volatile solid state storage devices. In some embodiments, the memory 506 includes one or more storage devices remotely located from one or more processing units 502. The memory 506, or alternatively the non-volatile memory within memory 506, includes a non-transitory computer readable storage medium. In some embodiments, the memory 506, or the non-transitory computer readable storage medium of the memory 506, stores the following programs, modules, and data structures, or a subset or superset thereof:
an operating system 514, which includes procedures for handling various basic system services and for performing hardware dependent tasks;
a network communication module 516, which connects the server 500 to other devices (e.g., computing device(s) 400 and/or other servers 500) via one or more network interfaces (wired or wireless) and one or more communication networks, such as the Internet, other wide area networks, local area networks, metropolitan area networks, and so on;
a user interface module 518, which enables presentation of information (e.g., a graphical user interface for user application 524, web application 530 widgets, websites and web pages thereof, audio content, and/or video content) at the computing device 400 via one or more output devices 512 (e.g., displays or speakers);
an input processing module 520, which detects one or more user inputs or interactions from one of the one or more input devices 510 and interprets the detected input or interaction;
a web browser module 522, which navigates, requests (e.g., via HTTP), and displays websites and web pages thereof, including a web interface for logging into a user account of a user application 524;
one or more user applications 524, which are executed at the server 500;
a model training module 526, which trains a machine learning model 460, where the model 460 includes at least one neural network and is applied to execute machine learning algorithms for analyzing statistical data distributions of datasets 440 and identify which data points (e.g., data values or marks) should be grouped or simplified;
a web application 530 for optimizing the number of data points datasets that are used to render data visualizations, which may be downloaded and executed by a web browser 426 on a user's computing device 400. In general, a web application 530 has the same functionality as a desktop application 430, but provides the flexibility of access from any device at any location with network connectivity, and does not require installation and maintenance. In some embodiments, the web application 430 includes various software modules to perform certain tasks, such as:
   a user interface module 532, which provides the user interface for all aspects of the web application 530;
   a data processing module 534, which has the same functionalities as the data processing module 434; and
   a visualization generation module 536 for generating and displaying data visualizations;

In some embodiments, the server system 500 includes a database 540. In some embodiments, the database 540 includes zero or more datasets or data sources 440, which are used by the user application(s) 524, web application 530, and model training module 536, and machine learning models 460. In some embodiments, the datasets/data sources 440 include a first dataset or a first data source (e.g., dataset/Data source 1 440-1). In some embodiments, a respective dataset or data source 440 includes data fields 442, data values 444 (e.g., data points) corresponding to the data fields, and metadata 446 of the data fields and/or data values. In some embodiments, the database 540 stores machine learning models 460.

In some embodiments, the memory 506 stores APIs 550 for receiving API calls from one or more applications (e.g., user application(s) 524, web application 530, and/or model training module 526), translating the API calls into appropriate actions, and performing one or more actions.

Each of the above identified executable modules, applications, or sets of procedures may be stored in one or more of the previously mentioned memory devices, and corresponds to a set of instructions for performing a function described above. The above identified modules or programs (i.e., sets of instructions) need not be implemented as separate software programs, procedures, or modules, and thus various subsets of these modules may be combined or otherwise re-arranged in various embodiments. In some embodiments, the memory 506 stores a subset of the modules and data structures identified above. Furthermore, the memory 506 may store additional modules or data structures not described above.

Although FIG. 5 shows a server system 500, FIG. 5 is intended more as a functional description of the various features that may be present rather than as a structural schematic of the embodiments described herein. In practice, and as recognized by those of ordinary skill in the art, items shown separately could be combined and some items could be separated. In addition, some of the programs, functions, procedures, or data shown above with respect to a server system 300 may be stored or executed on a computing device 400. In some embodiments, the functionality and/or data may be allocated between a computing device 400 and one or more servers 500. Furthermore, one of skill in the art recognizes that FIG. 5 need not represent a single physical device. In some embodiments, the server functionality is allocated across multiple physical devices in a server system. As used herein, references to a “server” include various groups, collections, or arrays of servers that provide the described functionality, and the physical servers need not be physically colocated (e.g., the individual physical devices could be spread throughout the United States or throughout the world).

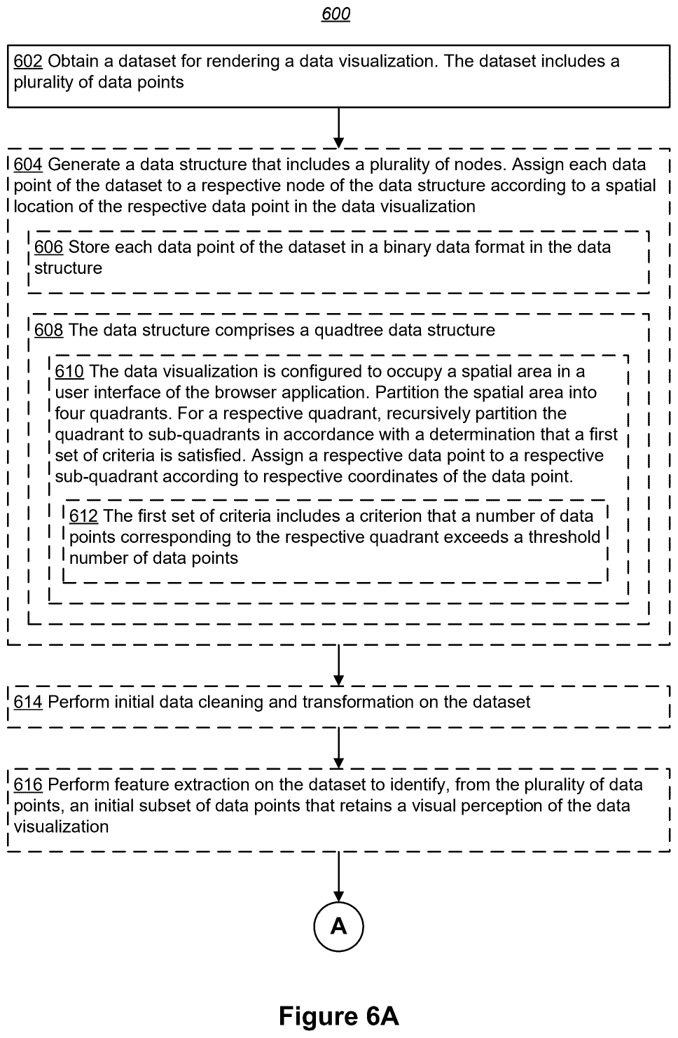

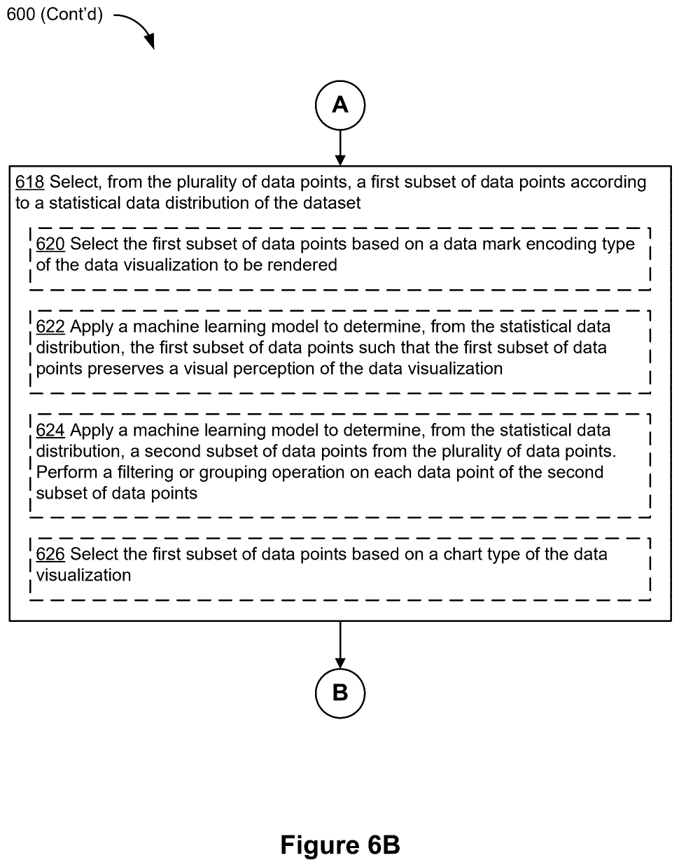

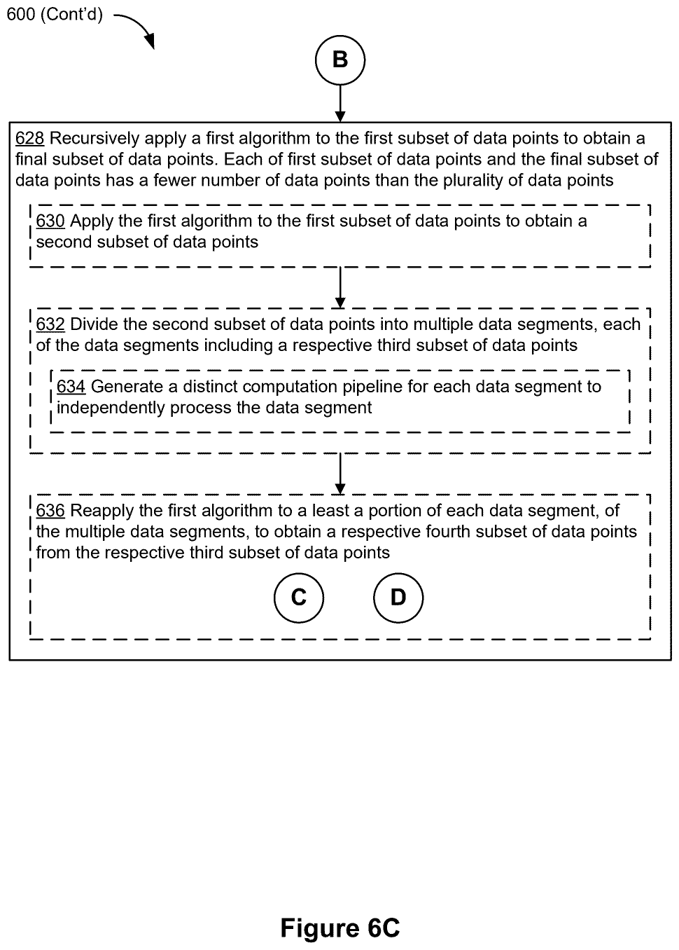

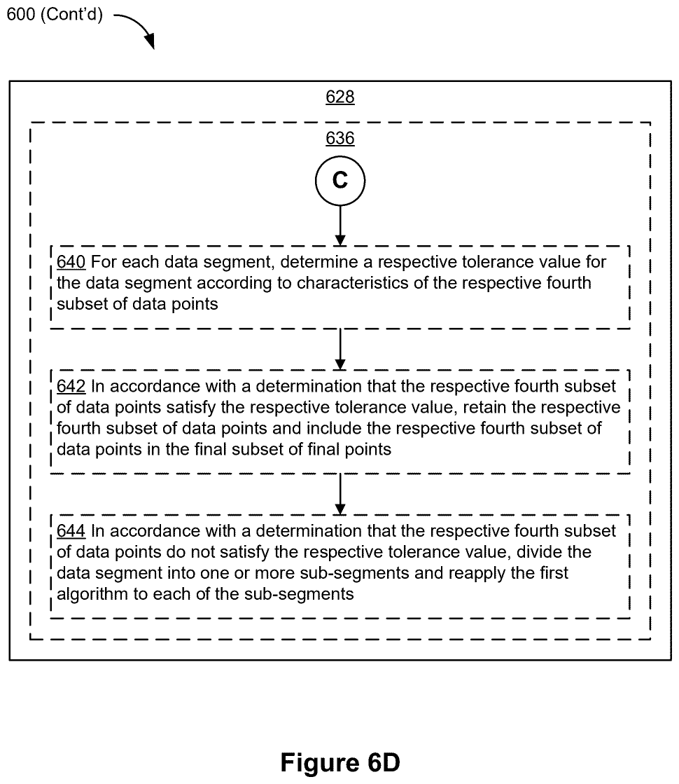

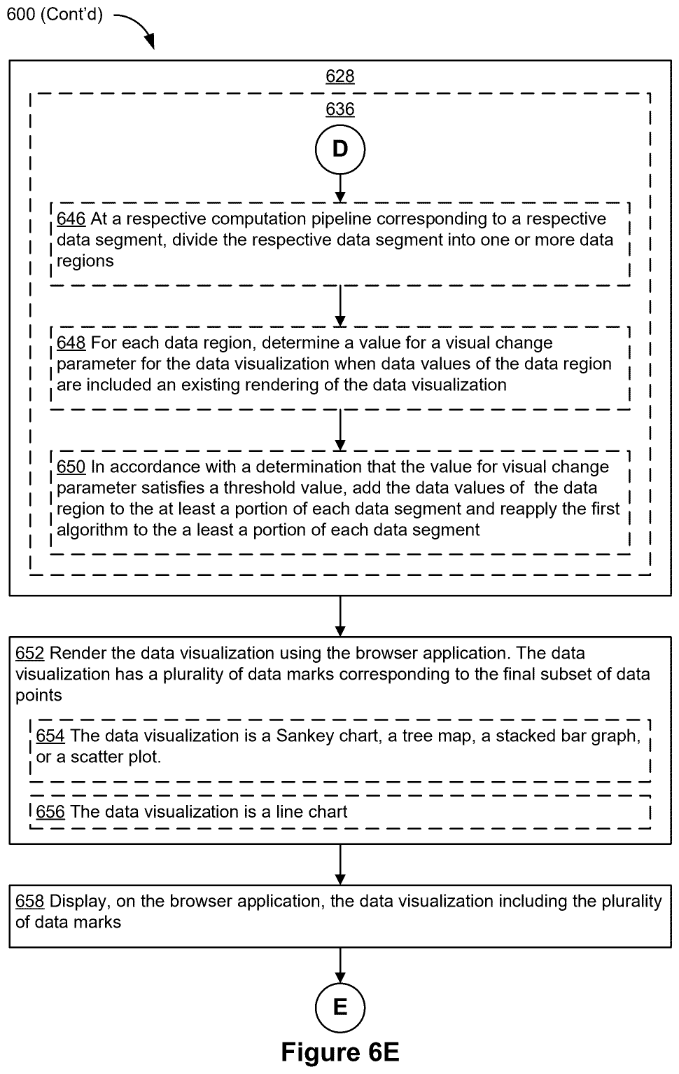

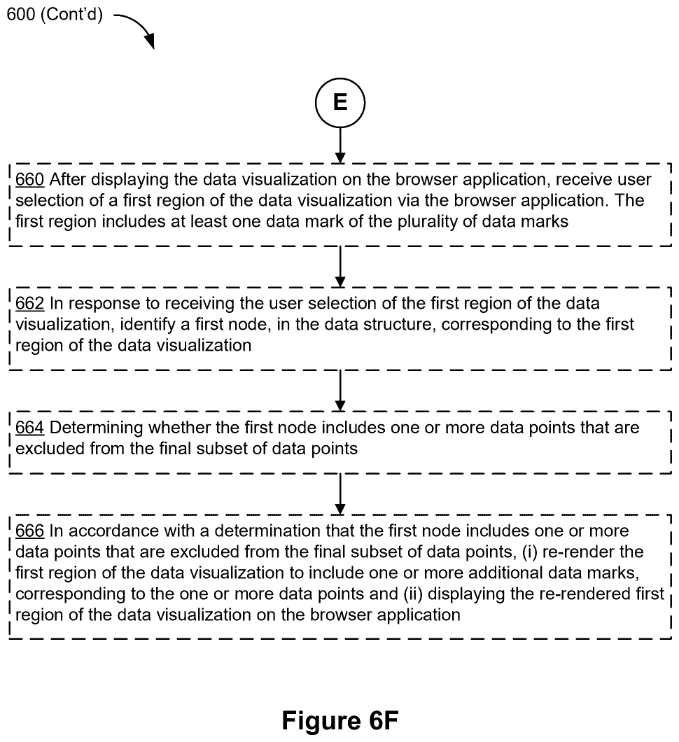

FIGS. 6A to 6F provide a flowchart of an example process for visualizing large datasets, in accordance with some embodiments. The method 600 is performed at a computing device (e.g., computing device 400) executing a browser application (e.g., application 430). The computing device includes one or more processors (e.g., CPU(s) 402) and memory (e.g., memory 406). In some embodiments, the memory stores one or more programs or instructions configured for execution by the one or more processors. In some embodiments, the operations shown in FIGS. 1, 2, and 3 correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 600 may be combined and/or the order of some operations may be changed.

The computing device obtains (602) a dataset for rendering a data visualization, the dataset including a plurality of data points (e.g., data values). In some embodiments, the plurality of data points comprises at least 100,000 data points, 500,000 data points, 1 million data points, 5 million data points, 10 million data points, 50 million, or 100 million data points.

In some embodiments, the computing device, after obtaining the dataset, generates (604) a data structure that includes a plurality of nodes. The computing device assigns each data point, of the plurality of data points of the dataset, to a respective node of the data structure according to a spatial location (e.g., spatial coordinates) of the respective data point in the data visualization.

In some embodiments, the computing device stores (606) each data point of the dataset in a binary data format in the data structure.

In some embodiments, the data structure comprises (608) a quadtree data structure.

In some embodiments, the data visualization occupies (610) a spatial area (e.g., two-dimensional space) in a user interface (e.g., user interface 432) of the browser application. The computing device partitions the spatial area into four quadrants (each quadrant corresponding to a respective sub-area of the data visualization). For a respective quadrant, the computing device recursively partitions the quadrant to sub-quadrants in accordance with a determination that a first set of criteria (e.g., one or more criteria) is satisfied. The computing device assigns a respective data point to a respective sub-quadrant according to respective coordinates of the data point.

In some embodiments, the first set of criteria includes (612) a criterion that a number of data points corresponding to the respective quadrant exceeds a threshold number of data points.

In some embodiments, after obtaining the dataset (and prior to selecting a first subset of data points), the computing device performs client-side data pre-processing. For example, in some embodiments, the computing device performs (614) (e.g., via data processing module 434) initial data cleaning and transformation. This can include handling missing values, filtering outliers, normalizing data, and converting data types. In some embodiments, pre-processing ensures that the data is in the best possible shape for rendering, reducing the likelihood of errors and inconsistencies.

In some embodiments, the computing device perform (616) (e.g., via data processing module 434) feature extraction on the dataset to identify, from the plurality of data points, an initial subset of data points that retains a visual perception of the data visualization.

Referring to FIG. 6B, the computing device selects (618) (e.g., samples), from the plurality of data points, a first subset of data points according to a statistical data distribution of the dataset.

In some embodiments, the computing device selects the first subset of data points according to characteristics of the statistical data distribution characteristics.

For example, the characteristics of the data distribution that influence whether or not to select a data point can include an occurrence of null values or zero values in the dataset. In some embodiments, the computing device 400 (or the server 500) calculates the sparsity and spread or null values or zero values in the dataset. A null value indicates that a value does not exist (or is unknown) whereas a zero value indicates the data value is zero. In some embodiments, the null/zero values are the first candidates for removal (i.e., not selected or included in the first subset of data points). The calculations for null values are defined as:
Proportion of Null Values per Feature: In each column of the dataset
Pnull,j=Total number of entries in feature j/Number of null values in feature j
Spread of Null values:

$$Mean , {μ}_{null} = \frac{1}{M} {\sum }_{j = 1}^{M} {P}_{null , j} \qquad ( 1 )$$

$$Variance , {σ}_{n u l l}^{2} \frac{1}{M} {\sum }_{j = 1}^{M} {( {P}_{null , j} - {μ}_{n u l l} )}^{2} \qquad ( 2 )$$

$$Standard Deviation , {σ}_{null} = \sqrt{{σ}_{n u l l}^{2}} \qquad ( 3 )$$

Similar definitions apply in the case of spread of zero values. In some embodiments, the computations are pre-processed at the computing device 400. In some embodiments, the computations are pre-processed at the server 500.

As another example, the characteristics of the data distribution that influence whether or not to select a data point can include a frequency of occurrence of a set of values within a specific partition/region of the data visualization to be rendered based on the data. For example, in some embodiments, the computing device 400 (or the server 500) can separate the data into partitions or regions (e.g., according to the spatial position of the data in the data visualization), and the frequency of occurrence of a set of values within a specific partition/region (e.g., radius) is determined. This is an iterative method where the objective is to find a data point and determine how many values fall within a specific range of that data point to minimize human perceptive difference in charts.

In yet another example, the characteristics of the data distribution that influence whether or not to select a data point can include a distance between two data marks in a “densely populated” region of a visualization (e.g., distance calculation for each dense region from above step). For example, if a region has 100 marks and the distance between a random mark A and a random mark B is 5 pixels (˜1.3 mm) with a P99 of 2 mm, then all marks below 2 mm (9 pixels) is dropped from the initial rendering. However, these are kept in memory to flash render if the user zooms in a particular zone in the chart.

Another characteristic of the data is the viewport and rendering sequence based on high spread and freshness. When the data has latest values (if grouped by time or new upserts), these data points are given first priority to render and subsequent rendering happens on descending sorted order of values. Similarly for viewport, only the rendering happens within the viewport which is visible to user based on screen size. Dense data regions are calculated for the entire dataset that needs to be rendered. The priority of rendering is given first to less dense regions and very dense regions of data is rendered at the end.

In some embodiments, the subset of data points are selected at regular intervals (e.g., sampling rate), such as one out of every three data points, or one out of every five data points).

With continued reference to FIG. 6B, in some embodiments, the computing device selects (620) the subset of data points based on a data mark encoding type of the data visualization to be rendered. (e.g., a shape of the encoding, whether the data mark encoding comprises an open circle such as those in the examples of FIGS. 1, 2, and 3, or whether the data marks comprise solid fill.) Using FIG. 3 as an example, suppose the clusters 302 and 312 comprise data marks that are encoded with a solid fill, the computing device may be able to remove some of the overlapping data marks (e.g., data points) located at the top right corner of the cluster 312, because the change in appearance will not be apparent whether there is one data mark with a solid fill or two data marks with solid fill that completely overlap each other.

In some embodiments, the computing device selects the first subset of data points by applying (624) a machine learning model (e.g., machine learning models 460) to determine, from the data distribution (e.g., in real time), the first subset of (e.g., one or more) data points such that the first subset of data points preserves a visual perception of the data visualization. For example, in some embodiments, the machine learning model can execute an algorithm that calculates the distribution of the data points and identifies clusters, outliers, and patterns that are crucial for an accurate and meaningful visualization.

In some embodiments, the computing device applies (624) a machine learning model to determine, from the data distribution, a second subset of data points (e.g., one or more data points) from the plurality of data points, and performs a filtering or grouping operation on each data point in the second subset of data points.

In some embodiments, the computing device selects the subset of data points based on a chart type of the data visualization to be rendered.

The computing device recursively applies (628) a first algorithm (e.g., DP algorithm or VW algorithm) to the first subset of data points to obtain a final subset of data points. Each of first subset of data points and the final subset of data points has a fewer number of data points than the plurality of data points.

In some embodiments, the final subset of data points includes a data point that is present in the first subset of data points.

In some embodiments, recursively applying the first algorithm to the first subset of data points to obtain the final subset of data points includes applying (630) the first algorithm to the first subset of data points to obtain a second subset of data points (e.g., by selecting, from the first subset of data points, the more significant points and discarding the less significant ones based on a tolerance level), and dividing (632) the second subset of data points into multiple (e.g., non-overlapping) data segments, each of the data segments including a respective third subset of data points.

In some embodiments, the computing device generates (634) (e.g., spawns, implements, or executes) a distinct computation pipeline (e.g., web worker) for each data segment, of the multiple segments, to independently process the segment. In some embodiments, recursively applying the first algorithm to the first subset of data points to obtain the final subset of data points includes reapplying (636) the first algorithm to a least a portion of each data segment, of the multiple data segments, to obtain a respective fourth subset of data points from the respective third subset of data points. The number of data points in the fourth subset is fewer than the number of data points in the third subset.

In some embodiments, when performing incremental simplification on each data segment, the first algorithm works only on the reduced dataset based on the first subset of data. However, the original data points are kept in memory and once the first phase of rendering is complete with all sampled data, a set of web workers add the original marks so as to give a complete viz.

With continued reference to FIG. 6D, in some embodiments, for each data segment, the computing device determines (640) (e.g., dynamically, in real time, on-the-fly) a respective tolerance value, for the respective data segment, according to characteristics of the respective fourth subset of data points. The computing device, in accordance with a determination that the respective fourth subset of data points (e.g., each data point in the respective third subset) satisfies (642) the respective tolerance value, retains the respective fourth subset of data points and includes (e.g., adds) the respective fourth subset of data points in the final subset of final points. In some embodiments, the computing device, in accordance with a determination that the respective fourth subset of data points does not satisfy (644) the respective tolerance value, divides the data segment into one or more sub-segments and reapplies the first algorithm to each of the sub-segments.

Referring now to FIG. 6E, in some embodiments, the computing device, at a respective computation pipeline corresponding to a respective data segment, divides (646) the respective data segment into one or more data regions. A data region is a closely spaced data tuple which, when rendered, will be occupying a specific region of the screen.

For example, in a segment of 20 values below, there will be six data regions based on the data characteristics defined above:

$$\{ 2 , 3 \text{.1} , 18 , 230 , 1 , 0 , 9 , 3 , 4 , 1 , 78 , 56 , 32 , 18 , 16 , 12 , 1 , 109 , 11 , 20 \} -- > \{ 2 , 3.1 , 1. , 3 , 4 , 1 , 1 \} , \{ 9 , 12 , 11 \} , \{ 18 , 18 , 16 , 20 \} , \{ 230 \} , \{ 78 , 56 \} , \{ 32 \} ,$$

$$and \{ 109 \} \}$$

For each data region, the computing device determines (648) a value for a visual change parameter (e.g., visual change parameter) for the data visualization when data values of the data region are included an existing rendering of the data visualization. In accordance with a determination that the value for visual change parameter satisfies a threshold value, the computing device adds (650) the data region to the at least a portion of each data segment and reapplies the first algorithm to the a least a portion of each data segment.

The computing device renders (652) (e.g., generates) a data visualization (e.g., data visualization 200) using the browser application (e.g., natively or locally on the device, without any server-side interaction). The data visualization includes a plurality of data marks corresponding to the final subset of data points (e.g., each data mark corresponds to a data point in the final subset of data points) (e.g., 100% client-side rendering, rendering is performed in the web browser application).

In some embodiments, the data visualization is (654) a Sankey chart, a tree map, a stacked bar graph, or a scatter plot.

In some embodiments, the data visualization is (656) a line chart.

In some embodiments, the disclosed algorithm (e.g., algorithm(s) 436) follows a defined strategy for a respective chart type. For example, for scatter chart, the algorithm can use a cluster modification algorithm such as Density-Based Spatial Clustering of Applications with Noise (DBSCAN) with Euclidean distance before applying the DP algorithm. In the case of a bar chart, the algorithm adds buckets and aggregation (by combining adjacent bars—wider bars) and then applying DP algorithm.

In some embodiments, for Sankey charts, the tolerance calculation for the DP algorithm is based on flow width (e.g., a minimum width of the flows to ensure that significant flows are preserved) and path deviation (e.g., a perpendicular distance between the original path and its simplified version).

In some embodiments, for tree maps, the tolerance includes rectangle size (e.g., based on the percentage deviation allowed in rectangle sizes while preserving the hierarchical structure) and position deviation (e.g., deviations in rectangle positions to maintain the overall structure).

The computing device displays (658), on the browser application, the data visualization including the plurality of data marks.

Referring to FIG. 6F, in some embodiments, after displaying the data visualization on the browser application, the computing device receives (660) user selection of a first region of the data visualization. The first region includes at least one data mark of the plurality of data marks. The computing device, in response to receiving the user selection of the first region of the data visualization, identifies (662) a first node, in the data structure, corresponding to the first region of the data visualization. In accordance with a determination that the first node includes one or more data points that are excluded from the final subset of data points, the computing device re-renders (666) (e.g., dynamically, in-real time) the first region of the data visualization to include one or more additional data marks, corresponding to the one or more data points; and displays the re-rendered first region of the data visualization.

For example, when a user wishes to explore a segment of the data visualization, the user can move their cursor around the segment. In some embodiments, the algorithm tracks the pixel movement using a separate web worker (separate from web workers of the main thread which render the visualization). As soon as the algorithm determines that the user is trying to move to a rectangle rectangular quarter, a quadrant which is already being sampled, it will trigger a spawning of a new web worker which would try to flash render the specific quadrant where the user is trying to move so that the user does not lose the fidelity of that specific area that specific segment.

In accordance with some embodiments, for a visualization with 10 million data points, the disclosed approach reduces JavaScript memory by ˜78% (e.g., from 275 MB to 63 MB in benchmark); the rendering time reduces by ˜99% (e.g., from 6 seconds to 50 milliseconds in benchmark); and the load time (user visual latency) decreases by ˜90% (from 16.9 seconds to 1.8 seconds for parent charting function). The gains are highly configurable since the optimization uses dynamic run-time tolerance (e.g., a function of DP algorithm) and adaptive quadtree nodes (e.g., minimum 15% with least tolerance and 99% with max tolerance).

Table 1 below shows the optimized performance values compared to the baseline values, in accordance with some embodiments.

TABLE 1
Performance Values

| | | | JavaScript | | | | | |
|---|---|---|---|---|---|---|---|---|
| | | | Memory | | Rendering | | | |
| Type | Element | Chart Type | (Average) | | Time | | Load Time | |
| Baseline | Scalable Vector | Line/Bar | 275 | MB | 6 | s | 16.9 | sec |
| | Graphics (SVG) | | | | | | | |
| Baseline | Canvas | Scatterplot | 112 | MB | 800 | ms | 11 | sec |
| Optimized | SVG | Line/Bar | 63 | MB | 50 | ms | 1.78 | sec |
| Optimized | Canvas | Scatterplot | 71 | MB | 18 | ms | 1.5 | sec |

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or embodiments.

As used herein, the term “and/or” encompasses any combination of listed elements. For example, “A, B, and/or C” entails each of the following possibilities: A only, B only, C only, A and B without C, A and C without B, B and C without A, and a combination of A, B, and C.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for visualizing large datasets, performed by a computing device executing a browser application, the method comprising:
obtaining a dataset for rendering a data visualization, the dataset including a plurality of data points;
selecting, from the plurality of data points, a first subset of data points according to a statistical data distribution of the dataset;
recursively applying a first algorithm to the first subset of data points to obtain a final subset of data points, wherein each of first subset of data points and the final subset of data points has a fewer number of data points than the plurality of data points;
rendering a data visualization using the browser application, the data visualization having a plurality of data marks corresponding to the final subset of data points; and
displaying, on the browser application, the data visualization including the plurality of data marks.

2. The method of claim 1, wherein recursively applying the first algorithm to the first subset of data points to obtain the final subset of data points includes:
applying the first algorithm to the first subset of data points to obtain a second subset of data points;
dividing the second subset of data points into multiple data segments, each of the data segments including a respective third subset of data points; and
reapplying the first algorithm to a least a portion of each data segment, of the multiple data segments, to obtain a respective fourth subset of data points from the respective third subset of data points.

3. The method of claim 2, wherein reapplying the first algorithm to the a least a portion of each data segment to obtain the respective fourth subset of data points:
for each data segment:
determining a respective tolerance value for the data segment according to characteristics of the respective fourth subset of data points;
in accordance with a determination that the respective fourth subset of data points satisfy the respective tolerance value:
retaining the respective fourth subset of data points; and
including the respective fourth subset of data points in the final subset of final points; and
in accordance with a determination that the respective fourth subset of data points do not satisfy the respective tolerance value:
dividing the data segment into one or more sub-segments; and
reapplying the first algorithm to each of the sub-segments.

4. The method of claim 2, further comprising:
generating a distinct computation pipeline for each data segment, of the multiple data segments, to independently process the data segment.

5. The method of claim 4, further comprising:
at a respective computation pipeline corresponding to a respective data segment:
dividing the respective data segment into one or more data regions; and
for each data region:
determining a value for a visual change parameter for the data visualization when data values of the data region are included an existing rendering of the data visualization; and
in accordance with a determination that the value for visual change parameter satisfies a threshold value:
adding the data region to the at least a portion of each data segment; and
reapplying the first algorithm to the a least a portion of each data segment.

6. The method of claim 1, further comprising:
after obtaining the dataset:
generating a data structure that includes a plurality of nodes; and
assigning each data point of the dataset to a respective node of the data structure according to a spatial location of the respective data point in the data visualization.

7. The method of claim 6, further comprising storing each data point of the dataset in a binary data format in the data structure.

8. The method of claim 6, wherein the data structure comprises a quadtree data structure.

9. The method of claim 6, wherein:
the data visualization occupies a spatial area; and
the method includes:
partitioning the spatial area into four quadrants; and
for a respective quadrant:
recursively partitioning the quadrant to sub-quadrants in accordance with a determination that a first set of criteria is satisfied; and
assigning a respective data point to a respective sub-quadrant according to respective coordinates of the data point.

10. The method of claim 9, wherein the first set of criteria includes a criterion that a number of data points corresponding to the respective quadrant exceeds a threshold number of data points.

11. The method of claim 6, further comprising:
after displaying, on the browser application, the data visualization:
receiving user selection of a first region of the data visualization, the first region including at least one data mark of the plurality of data marks; and
in response to receiving the user selection of the first region of the data visualization:
identifying a first node, in the data structure, corresponding to the first region of the data visualization;
in accordance with a determination that the first node includes one or more data points that are excluded from the final subset of data points:
re-rendering the first region of the data visualization to include one or more additional data marks, corresponding to the one or more data points; and
displaying the re-rendered first region of the data visualization.

12. The method of claim 1, further comprising:
after obtaining the dataset and prior to selecting the first subset of data points:
performing initial data cleaning and transformation.

13. The method of claim 1, further comprising:
after obtaining the dataset and prior to selecting the first subset of data points:
performing feature extraction on the dataset to identify, from the plurality of data points, an initial subset of data points that retains a visual perception of the data visualization.

14. The method of claim 1, wherein the selecting the first subset of data points is further based on a data mark encoding type of the data visualization.

15. The method of claim 1, wherein selecting, from the plurality of data points, the first subset of data points according to the data distribution of the dataset includes:
applying a machine learning model to determine, from the statistical data distribution, the first subset of data points such that the first subset of data points preserves a visual perception of the data visualization.

16. The method of claim 1, wherein selecting, from the plurality of data points, the first subset of data points according to the data distribution of the dataset includes:
applying a machine learning model to determine, from the statistical data distribution, a second subset of data points from the plurality of data points; and
performing a filtering or grouping operation on each data point of the second subset of data points.

17. The method of claim 1, wherein the first subset of data points is selected further based on a chart type of the data visualization.

18. The method of claim 1, wherein the data visualization is a Sankey chart, a tree map, a stacked bar graph, a scatter plot, or a line chart.

19. A computing device executing a browser application, comprising:
a display;
one or more processors; and
memory coupled to the one or more processors, the memory storing one or more programs configured for execution by the one or more processors, the one or more programs including instructions for:
obtaining a dataset for rendering a data visualization, the dataset including a plurality of data points;
selecting, from the plurality of data points, a first subset of data points according to a statistical data distribution of the dataset;
recursively applying a first algorithm to the first subset of data points to obtain a final subset of data points, wherein each of first subset of data points and the final subset of data points has a fewer number of data points than the plurality of data points;
rendering a data visualization using the browser application, the data visualization having a plurality of data marks corresponding to the final subset of data points; and
displaying, on the browser application, the data visualization including the plurality of data marks.

20. A non-transitory computer-readable storage medium storing one or more programs configured for execution by one or more processors of a computing device executing a browser application, the one or more programs comprising instructions for:
obtaining a dataset for rendering a data visualization, the dataset including a plurality of data points;
selecting, from the plurality of data points, a first subset of data points according to a statistical data distribution of the dataset;
recursively applying a first algorithm to the first subset of data points to obtain a final subset of data points, wherein each of first subset of data points and the final subset of data points has a fewer number of data points than the plurality of data points;
rendering a data visualization using the browser application, the data visualization having a plurality of data marks corresponding to the final subset of data points; and
displaying, on the browser application, the data visualization including the plurality of data marks.
